(19) United States
(12) Patent Application Publication
(10) Pub. No.: US 2006/0026669 A1
(43) Pub. Date: Feb. 2, 2006

(54) System and method of characterizing and managing electronic traffic

(76) Inventor: Phillip H. Zakas, Washington, DC (US)

Correspondence Address: PILLSBURY WINTHROP SHAW PITTMAN, LLP, P.O. BOX 10500, MCLEAN, VA, 22102, US

(21) Appl. No.: 11/192,395

(22) Filed: Jul. 29, 2005

Related U.S. Application Data
(60) Provisional application No. 60/591,872, filed on Jul. 29, 2004.
(60) Provisional application No. 60/591,874, filed on Jul. 29, 2004.

(51) Int. Cl. H04L 9/32

(52) U.S. Cl. 726/6

(57) ABSTRACT

A system and method for monitoring and dynamically managing all user traffic at point of log-in and throughout a user's network experience. Rules may be enforced based on observed traffic of users at and after log-in and up until log off. The system automatically detects network traffic and dynamically responds to potential attacks with extremely high speed and efficiency. Rich Traffic Analysis (RTA) offers greater network traffic characterization accuracy, detection speed, network management options and intrusion prevention capabilities. The system has ability to view all network traffic in the full context of users, applications, data and system access which offers strong, verifiable and accurate protection of networked assets. The system employs several traffic sensor devices communicating with a central manager device enabling the high-speed characterization of each network packets traversing the network. This provides a more solid basis for legitimately taking action and enforcing rules on the observed traffic.

### CROSS REFERENCE

This present application claims benefit to Provisional Application Nos. 60/591,874, and 60/591,872 both filed Jul. 29, 2004, the specifications of which are incorporate herein in their entireties.

### FIELD OF INVENTION

The invention relates to computer security and network management, and particularly to analyzing and managing network traffic in or between network assets by using rules, permissions and watch lists in order to dynamically detect and react in real-time to movement of data across networks, user network activity and application network traffic.

### BACKGROUND

Existing electronic security systems either attempt to identify unauthorized network and system access, known as an “intrusion” in the computer security field, or attempt to prevent intrusions by restricting access to network communication channels and systems. Intrusions may occur under a variety of circumstances and for a variety of reasons, including for example, when an attacker attempts to cause harm by modifying, stealing, deleting or hiding data residing within a network or system. Various other scenarios are known. Some intrusion attempts can be detected and effectively neutralized by the target systems. Other intrusions cannot be effectively neutralized by the target system. For example, in some scenarios this is because of the sophistication of the attack, or because the intruder has neutralized the security systems prior to an unauthorized data access attempt, because the intruder has obtained and used the authentication credentials of an authorized user, because the attacker is an insider with appropriate authorization to access systems and data or for other reasons. For these and other reasons, existing electronic security systems often fail to detect and neutralize intrusions, data theft and/or data manipulation. They suffer from other drawbacks as well.

There are at least four core security technologies in use today: firewalls, intrusion detection/prevention systems, log file scanners/security information managers and access control systems. All four technologies generally focus on protecting the perimeter of a network or enforcing access control policies to specific systems. These security systems typically are not designed to monitor the movement of data as it travels across networks to detect and prevent authorized data manipulation or disclosure or for other reasons.

A firewall can provide some level of security against an intruder who is not operating within a target network. However, a firewall cannot prevent intrusions once it has approved access to an internal system from outside the network, or if the attack originates from within a network and is thus not subject to restriction by a firewall, or if the attack occurs over an open firewall port. Sophisticated intrusion attempts may target the firewall itself for neutralization, leaving an entire system or network exposed to intruders. Furthermore, very high capacity connectivity can operate at data speed exceeding the operating specifications of firewalls, leaving very high speed connections unprotected. Firewalls suffer other drawbacks as well.

Intrusion detection/prevention systems can detect many types of intrusions, for example, by relying upon a database of known attack “signatures,” by detecting anomalous user behavior on a network and in other ways. A “signature” generally refers to a known sequence of data packets or commands transmitted by an intruder to a system in an effort to gain authorized access to that system. An “attack” generally refers to an intrusion attempt that is designed to gain unauthorized access to a system or network, or which is designed to disable a system or network. Other types of attacks are also known. Signature-based intrusion detection systems generally cannot detect intrusion attempts which: a) do not have a defined signature—almost all new attack types, by definition, require new attack signatures; b) occur outside the view of the intrusion detection system, such as attacks originating from within an internal system or attacks targeting a network which is not monitored by an intrusion detection system; c) occur over many hours, days or weeks and thus occur outside the visible window of time of the intrusion detection system; d) are masked by high traffic volumes causing intrusion detection systems to drop packets from scrutiny; or e) are designed to disable or disrupt the intrusion detection system. Many signature-based intrusion detection systems can be bypassed or neutralized. Signature-based intrusion detection systems suffer other drawbacks as well.

Intrusion detection systems which use anomaly detection often have many of the same or similar weaknesses as signature-based systems but also are prone to produce false intrusion alarms or often cannot detect attacks until hours, days or weeks after the completion of an attack. Anomaly-based detection systems suffer other drawbacks as well.

Even if signature-based and anomaly detection systems detect an attack, they are often unable to neutralize the attack or disrupt the resulting flow of information, installation of rogue programs on systems or creation of hidden communication channels for later exploitation by an attacker, among other things.

Log file scanners/security information managers examine router, firewall, intrusion detection/prevention system and system log files for signs of intrusions and attacks. Since scanners do not process packets in real time, attacks are detected after the fact. Additionally, scanners cannot detect attacks for which known signatures do not exist and the vast quantity of data produced by log files makes manual inspection tedious and prone to error. Other drawbacks also exist.

Access control systems are generally designed to force users to authenticate themselves before they are granted access to a restricted system or network, usually by forcing a user to present a username and password, a token-based authentication credential and/or other access control techniques. Access control can be embedded within a system or can be part of an external authentication system to request and inspect the credentials of users. If a user presents valid credentials he or she is granted access to restricted systems or networks. However, access control systems cannot determine with complete certainty that the bearer of access credentials is indeed the authorized user. Attackers may obtain access credentials to gain unauthorized access to systems. Furthermore, access control systems cannot determine if a credentialed user is appropriately handling information to which he has access. Nor do access control systems prevent authorized users from engaging in wrongdoing. Other drawbacks exist.

If the core information security technologies are ineffective, for one or more of these or other reasons, known systems generally cannot halt the manipulation or flow of information to unauthorized systems or users.

Existing information security systems either impose restrictions on how networked devices can communicate to one another, or use pre-defined databases of known attack methods to recognize and/or block unauthorized message traffic. Unauthorized messages exchanged over authorized channels are extremely difficult to detect, and sometimes impossible to block without impacting the delivery of authorized messages. Traditional intrusion detection and intrusion prevention systems are limited to detecting known attacks at the expense of high alert volumes and they are unable to recognize many forms of successful targeted attacks.

When an attack on a target system occurs, the damage or theft of information may be extremely costly to repair. These and other drawbacks exist with known systems.

### SUMMARY

The invention addresses these and other drawbacks of known systems. For example, one aspect of the invention relates to a system and method for monitoring and regulating the flow of network traffic over a network to increase the security of the information residing on a target system or server. The present invention monitors and dynamically manages all user traffic not only at point of log-in but through out a user's network experience. Rules may be enforced based on observed traffic of users at and after log-in and up until log off. Another aspects relates to automatically detecting network traffic and responding to potential attacks with extremely high speed and efficiency. Rich Traffic Analysis (RTA) offers greater network traffic characterization accuracy, detection speed, network management options and intrusion prevention capabilities than systems which do not include RTA technology. The present invention has the ability to view all network traffic in the full context of users, applications, data and system access which offers strong, verifiable and accurate protection of networked assets. Yet another aspect of the invention employs traffic sensor devices communicating with a central manager device enabling the high-speed characterization of each network packets traversing the network. This provides a more solid basis for legitimately taking action and enforcing rules on the observed traffic. Also, in order to prevent attacks a zero-day analysis mechanism is employed to create signatures or traffic profiles for potential attacks characterized by repetitive handshake or packet traffic. Unusual traffic patterns are observed in order immediately block such types of traffic and any future observances of such traffic. These and other aspects of the invention improve information security and dynamically make real-time network adjustments in response to traffic attempting to traverse the network.

One embodiment of the invention includes a Dynamic Directory Enabled Service (DDES) architecture that may include a plurality of traffic sensors, a plurality of network assets (e.g. users, clients, host, server, workstations) and/or a central manager. The central manager may have a directory component, a control component and/or other components.

A directory may be used to manage user accounts and network permissions for users and assets of a network. Users may be assigned business roles in order to manage multiple user permissions in parallel. The control component receives network permissions from the directory component and converts them into primary policies and exception policies. Policies including, but not limited to, QoS levels, access rights, bandwidth utilization, secure transfer, and/or data encryption may be varied according to the role of a user within an organization. The control component monitors network activity observed by traffic sensors employing RTA in order to identify who is accessing the network, which resources are accessed, which applications are used to generate traffic and/or what data is being exchanged. Traffic sensors are installed at various places throughout the network for collecting and analyzing data as it flows across the network. They enforce various rules and policies stored in the main directory. Traffic sensors may receive instructions from the control component for the enforcement of rules and policies set forth in the main directory system.

An additional embodiment relates to a method for enforcing various network management policies (e.g., QoS, VLAN, security, bandwidth) in accordance with a watch list created at the directory. The central manager automatically updates a watch list of objects including, data keywords, digital watermarks, traffic profiles, network subnets, networked devices and other objects from data collected at traffic sensors. Certain keywords or digital watermarks may be an indication that sensitive or suspicious traffic is attempting to traverse the network(s). Sensitivity levels may be assigned to objects within the watch list.

According to another aspect of the invention, a watch list and directory rules may be broken into smaller components and distributed across several traffic sensors on a single network or host so that multiple evaluations can be performed in parallel on the same (or different) observed data or network packet streams. Based on traffic analysis, network activity may be deemed to be acceptable, unacceptable, or suspicious activity. Based on rules, certain actions may then be enforced.

In an additional embodiment, the system may use traffic profiles in order to determine whether observed traffic qualifies as a watch list match. Predefined confidence rating thresholds may be used to qualify traffic for corresponding policies or other action.

The system focuses on detecting and characterizing the activities of users and networked devices, application traffic and the movement of information using qualitative and quantitative measures to determine if the detected network traffic is authorized or unauthorized. The invention provides a method of quickly identifying and tracking unauthorized network traffic. Identified unauthorized network traffic can then be tallied, recorded, and/or carefully removed from authorized message traffic flows in real time. Various applications of this invention relate to the detection and blocking of zero-day (un-catalogued) worms, botnets and Trojan horses; unauthorized human reconnaissance efforts, attempts to compromise networks, attempts to compromise devices; unauthorized servers; unauthorized message sharing among devices and/or users; and/or other activity.

### BRIEF DESCRIPTION ON DRAWINGS

These and other features, aspects and advantages of the present invention will become better understood with reference to the following description, appended claims, and accompanying drawings where:

FIG. 1 is a block diagram of the network systems, according to an embodiment of the invention.

FIG. 2 is a block diagram of a sample packet within the traffic sensor, according to an embodiment of the invention.

FIG. 3 is a flow diagram for the method of identifying known and zero-day attacks, according to an embodiment of the invention

FIG. 4 is a flow diagram for the method of creating and distributing rules and watch list objects, according to an embodiment of the invention.

FIG. 5 is a flow diagram for the method of observing traffic at the traffic sensor according to watch list objects, according to an embodiment of the invention.

FIG. 6 is a flow diagram for the method of positively identifying traffic communications and assigning confidence ratings.

FIG. 7 is a flow diagram for the method executing role-based controls, according to an embodiment of the invention.

FIG. 8 is a flow diagram for the method of creating new watch list objects and rules based on unrecognized traffic, according to an embodiment of the invention.

### DETAILED DESCRIPTION

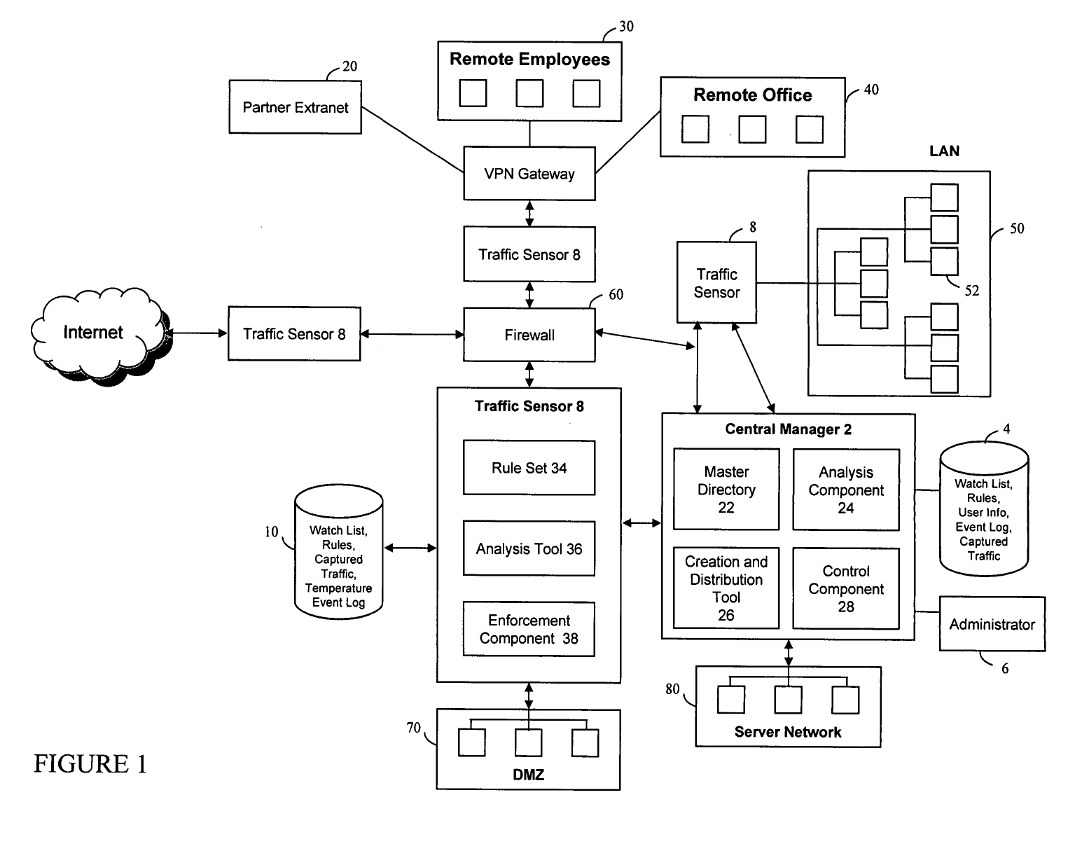

The description illustrates the invention by way of example and not by way of limitation. To achieve these and other objects the invention provides methods, systems, and computer program products for improving information security and network management. FIG. 1 shows an embodiment of the invention that employs a central manger 2 linked to a plurality of traffic sensors 8. Although, FIG. 1 depicts only two traffic sensors linked to the central manager it is understood that all traffic sensors communicate with a central manager. The traffic sensors 8 employ an RTA sensor that may be placed at various locations throughout one or more networks (e.g., corporate network(s), private network(s), and/or other network(s)) in order to provide true identification and control over network usage at any network segment. Traffic sensors may be implemented as computer program embedded within equipment having a programmed digital computer or processor anywhere within the flow of traffic. Types of equipment may include, but are not limited to, client machines (e.g., network interfaces, I/O ports), routers, switches, firewalls, proxy servers, gateways, and/or a standalone sensor. Traffic sensors may be positioned within key network traffic junctions, in order to most effectively manage and observe traffic.

FIG. 1 illustrates some examples of where the equipment may reside on a network in two configurations: inline and out-of-band. This system allows a coordinated view of traffic passing into, out of and throughout a network. The activity picked up by each traffic sensor 8 is transmitted back to a central manager 2 which offers an administrator 6 a real time view of network traffic, and a centralized point from which to instruct each traffic sensor 8 how to handle certain types of incidents in real-time. Like the traffic sensors 8 the centralized manger 2 may be embedded anywhere convenient to the administrator 6 of the network. Although FIG. 1 shows a the central manager 2 located at a server network, it is understood that the central manager may be implemented anywhere within the network (e.g. client machines, routers, switches, firewalls, proxy servers, gateways, and/or a standalone device). More than one central manager may exist for respective networks. Optionally, an integrated sensor and management console (not shown) may be used to manage a limited number of traffic sensors.

Traffic may be monitored at any vantage point between a source and destination. A strategic point in the network allows each traffic sensor to enforce security policies and block the flow of malicious traffic before it reaches servers, users, networked appliances, or any network resource. Types of traffic may include, application traffic (e.g., handshake, session messages, control messages), text, imagery, voice, data, video, audio, sensor output, network information, network packet headers, electronic impulses and/or other traffic. Transmissions may be in the form of data packet or signals, or portions of both data packets and signals transmitted between a variety of network assets including, but not limited to, personal computers (e.g. laptop), servers, hosts, hand held devices and/or other devices.

The invention can be applied to data networks, voice networks, wireless networks, mixed voice/data/video/audio networks and/or other networks. FIG. 1 also shows the system implemented within and between various network configurations including, but not limited to, Internet, Virtual Private Network (VPN), Gateway, DMZ, LAN, and Server Networks. In general, a VPN gateway allows remote employees 30, remote office 40, and partner extranet 20 access to internal LAN 50 or server network 80. Traffic detection and analysis may happen in multiple locations between various network locations and/or network assets (e.g. users, servers, firewall, etc.) including at the perimeter, DMZ, Internal network, and/or VPN/Extranet.

A traffic sensor placed at the perimeter of the network is the front line of defense against external threats and internal application and data misuse. Inbound and outbound network traffic is inspected for compliance with security policies at the transport, protocol, application and data layers, effectively blocking threats and assuring the highest level of network service availability for legitimate traffic. The benefits of perimeter control also include blocking of network reconnaissance and vulnerability scanning attempts by external attackers which protects assets on network interiors and perimeter assets such as firewall, servers, and users from external threats.

DMZ is a subnetwork that sits between a trusted internal network (e.g. corporate LAN) and an untrusted external network (e.g. Internet). A traffic sensor implemented at a DMZ may tightly secure web, email, DNS, and other services without impacting legitimate traffic flows by employing application layer default deny security policies. At this segment the traffic sensor may protect against the release of sensitive information over open network tunnels, limit network traffic to authorized application traffic, log access to assets within the DMZ, log traffic observed in the DMZ, and restrict administrative function to authorized administrators.

At the internal network a traffic sensor may offer virtual network segmentation at the application and data layers for a server and user network in order to continuously monitor the network for security violations and malicious code and implement role based controls. Role based controls restrict users to authorized application usage and system access (described further below). Activity logging performed by a traffic sensor may be used to log network traffic and user activity for policy compliance purposes or to retain forensic data for future investigation. In addition, a traffic sensor on an internal network works to eliminate unauthorized or rouge application traffic that introduce vulnerabilities and consume network bandwidth at the expense of authorized business applications.

At external networks like VPN or Extranets, where network administrators do not have control over devices and users connected to the external networks, the traffic sensors ensure that traffic passed through VPN's is limited to intended application traffic, users, server traffic and authorized data sharing in order to protect the network from threats of abuse that can be introduced to the network through remote endpoints that are not under the network administrator's control. Different levels of trust may be established for individual VPN connections so that some users are allowed more permissions than others.

Traffic sensors integrate transparently into a network and instantly provide real-time information about all network traffic activity. The traffic sensor instantly identifies all types of network traffic in real time, so problems can be found quickly and without the need for additional personnel or equipment. Each traffic sensor 8 shares packet capture data with the central manager 2 which may be stored locally within database 10. Thus, the administrator 6 can drill down into this information to identify what is traversing the network (network protocols, applications, data types, exploits), as well as track details of communications (e.g., which network assets and users are communicating over what ports), all the way down to specific packet captures. The traffic sensor characterizes every packet accurately through RTA that looks at the context, as well as the content, of the packet. Traffic sensors automatically identify, classify and track network traffic, instantly providing the system administrator with previously unknown information about network and application usage, data movement and potential policy violations. Since the approach combines network and security analysis, the administrator has all the tools necessary to ensure the network is optimized to support critical services and is secured against threats. The administrator can rely on actual network usage data (not theoretical or traffic estimates) to confidently create, manage and enforce policies that not only stop exploits, but address improper application usage that can hamper network availability. RTA provides traffic analysis and rule enforcement beyond the user login phase, which sets permissions at the beginning of a user login. RTA allows traffic to be dynamically managed while an already authorized network user is conducting network communications and during the entire time the user is on the network, and not just at the beginning of a user's session. Such a feature provides a more thorough basis of management on the network as a whole.

FIG. 1 depicts various components of the system employed to carryout the features discussed above. The system implements Dynamic Directory Enabled Services (DDES). One example of a DDES architecture includes a plurality of traffic sensors 8, a plurality of network assets (e.g. client workstations 52, hosts, servers) and/or a central manager 2. A central manger 2 is also linked to a storage component 4 which stores various data relating to watch lists, rules, captured packet data, rules, event logs, user information and/or other desired data. An administrator 6 may be provided a means to interface via a workstation or console having a user interface in order to manage components of the central manger 2. Linked to the central manager 2 are a plurality of traffic sensors 8 which transmit captured packet data and receive rules, policies and watch list objects from the central manager 2. The central manager 2 is designed for environments with multiple perimeter and internal network segments that need to be protected. All links are bi-directional communication links that allow data to flow into and out of the components attached.

As a high performance management console, the central manager 2 may comprise, a master directory 22, analysis tool 24, rules creation and distribution tool 26, and/or control component 28 to enable the central manager 2 to dynamically monitor and control the functions of each traffic sensor. The master directory 22 is used to manage user accounts and network permissions for known and unknown users and assets of a network. The master directory component 22 stores data including user profiles (e.g., functional role, directory group membership, machine addresses, IP address), user credentials (e.g., attributes, role based controls), watch list objects, predefined actions to be taken and various rules (e.g., security, Quality of Service, bandwidth, VLAN, traffic). Various types of network directory protocols including a Lightweight Directory Access Protocol (LDAP) may be implemented without deviating from the present invention. Types of directories implementing directory protocol may include, but are not limited to, Active Directory, offered as part of the Microsoft® Windows 2003 system, Novell® E-directory, offered by the Novell, or Sun™ ONE directory server offered by Sun™ Microsystems. Authentication systems such as Radius servers or the access control systems embedded in firewalls, routers, VPN concentrators, server operating systems and workstations include user information which may also be considered a source of directory information.

Information may be created via the creation and distribution tool 26, within the master directory 22 by one or more network administrators responsible for managing the entire network system or by authorized network assets (e.g. authorized client) with permissions to extend the directory, as detailed below. Due to the highly sensitive nature of information held within the master directory 22, limited or restricted access is allowed to the master directory. For example, authorized clients with sufficient permissions may be allowed restricted access to the master directory in order to extend an existing rule and/or set up traffic traps and receive traffic output activity events of interest to them. The network administrator 6, however, may be responsible for entering user profiles (e.g., group membership, machine addresses, IP address), user credentials (e.g., attributes, role based controls), watch list objects, predefined actions to be taken, various rules (e.g., security, Quality of Service, bandwidth, traffic) and/or other information.

The DDES architecture may be configured so that the central manager 2 may analyze captured packets as they are received from traffic sensors 8. The analysis component 24 examines the packet capture data presented by traffic sensors 8 in order to identify who is accessing the network, which resources are accessed, which applications are used to generate traffic, what data is being exchanged and/or other activity. Any or all of this information can be used by central manager 2 to create new rules for newly observed traffic.

The control component 28 instantiates master directory 22 information and translates the information into exception policies to be sent to traffic sensors 8. Directory information can be translated into policies that will be enforced by the traffic sensors 8. The control component 28 may create policies in real-time according to the information held within the master directory 22. For example, when a user is recognized as having logged in, his or her user credentials are pulled from the master directory 22 and policies can be generated that are enforced on the network. User credentials are translated into policies which are passed down to a specified traffic sensor or sensors used to enforce the policies against the newly logged in user. Policies may include role-based controls, discussed further below, which determine what user can an cannot do on the network. Other policy information may include actions to be taken for detected user or detected traffic such as, blocking traffic, adjusting QoS policies for a specific connection, logging the traffic, creating a temporary VLAN for the duration of a specific connection, and/or adopting security measures as necessary (tag packets, block connection, block port on a switch, reroute traffic, etc). The control component 28 may also periodically output activity events describing an incident in progress or share audit information with external network entities (databases, traffic sensors, clients, etc.) either automatically or through predefined traps set by authorized clients in the master directory. Mechanisms for outputting this information to the external network entities may include, real-time messages, e-mail, telephone call, text message, etc.

The creation and distribution tool 26 also enables instantiated rules, policies and other information to be distributed to the appropriate traffic sensors 8 in real-time. Traffic sensors 8 may receive instructions from the central manager 2 for the enforcement of rules and policies set forth by the master directory system. Thus, traffic sensors 8 allow network traffic to be dynamically managed, classified and monitored, as further described below.

Each traffic sensor 8 may have a rules set 34, an analysis tool 36, enforcement component 38, and/or other components. From FIG. 1 it should be understood that each traffic sensor comprises the components of the exemplary traffic sensor 8 depicted in the figure. The rules set 34 stores rules that are to be enforced by the traffic sensor 8. Each traffic sensor may have a different set of rules stored within the respective rules set 34 to enforce. The rules, which may include policies, are received from the central manager 2. The analysis tool 36 monitors and analyzes traffic against the rules set 36. Based on traffic observed passing through the traffic sensor the analysis tool may capture packet data which triggers the occurrence of a rule. The captured packet data is sent back to the central manager 2. Thus, the central manager is automatically receiving real-time reports about network activity. Rules within the rules set 36 are automatically enforced in real-time by the enforcement component 38. The enforcement component 38 executes the policies, for example, sending instructions to block traffic, adjusting QoS, block connection, block a port on a switch, reroute traffic and/or various other actions to be taken.

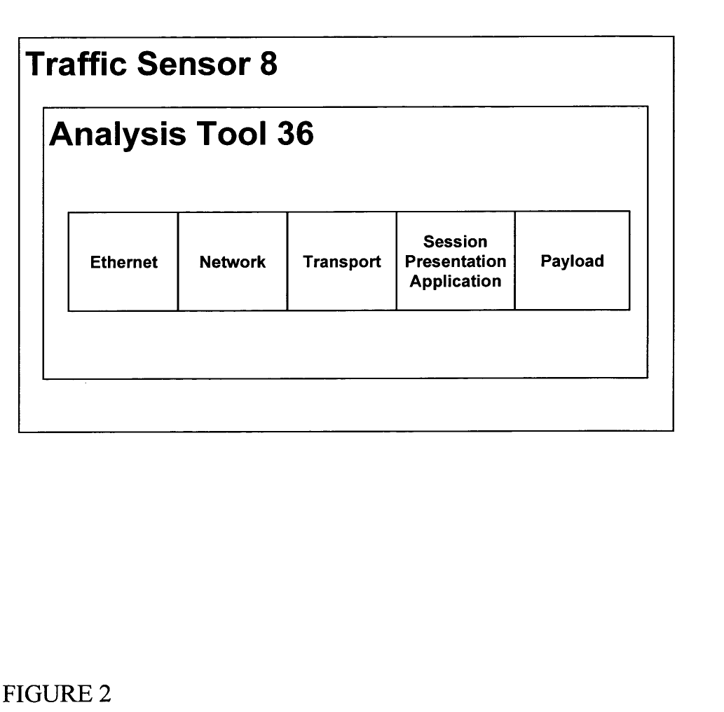

The system capabilities are further explained with respect to FIGS. 2-8. The RTA sensor 8 is capable of inspecting every Ethernet frame at full network speeds and loads without impacting network performance, and compared to existing security systems, the performance of the traffic sensor does not deteriorate dramatically as the number of patterns and rules is increased. FIG. 2 shows analysis tool 36 at each traffic sensor 8 designed to identify and classify all network traffic using data present in OSI layers 2-7 of every network frame, thereby linking traffic to applications, users, and network hosts to enable detailed identification and prevention of vulnerabilities, threats and policy violations. The analysis reveals a complete picture of the traffic on the network and provides a foundation on which to base the enforcement of various network policies defined by the central manager 2. Therefore, traffic is judged on the context of all network activity and content of each network packet. The Ethernet, Network and Transport layer packet data identify the context in which the packet is being sent. For example, source/destination MAC address, source/destination IP address, and source/destination port data. The Session, Presentation and Application layer packet data determine mainly the content of the packet including application, protocol, and payload data. Rules are enforced in real time response to traffic based on various traffic patterns found within the packet including application, protocol, attack, and presence of high-valued data. Identifying packets according to at least one of the four categories helps to quickly identify, manage, and determine whether a rule should be enforced on the traffic.

Application traffic may include all common network applications such as web, file transfer, email, instant messaging, remote access, file sharing applications, streaming and all of the major application used by enterprises. Application traffic may be detected independent of IP port number used by the traffic. Accurate identification of traffic that is encapsulated within other application protocols and communications is also possible. The central manager 2 may define how, where, and by whom applications may be used. This information may be passed down to the relevant traffic sensors 8 and their corresponding rules set 34 which enforce these acceptable use policies in real-time using the enforcement component 38. The traffic sensor identifies packets using a match by pattern process which employs RTA inspection of every network packet observed by a traffic sensor. Therefore, as an application, user or data element of a network packet is identified while crossing the traffic sensor, a corresponding policy, if one exists for the identified application, user or data element may be matched and immediately enforced. The traffic sensor may have a default policy to deny all traffic wherein the administrator makes rules to allow traffic. Conversely, a default policy may allow all traffic and have rules to deny certain kinds of traffic. The benefits of these policies include assuring critical network services are continuously available, while simultaneously stopping unauthorized network traffic thus increasing the performance and security of the network and devices connected to the network. Accurate application traffic identification can be used to eliminate rogue application and malware traffic which violate policies and are potential sources of security vulnerabilities and other risks, and it improves network performance and bandwidth utilization. In addition, traffic sensors inspect network traffic bi-directionally offering the ability to enforce rules differently for inbound vs. outbound network traffic.

The network protocols that underlie all application traffic are detected and logged, including all TCP/IP protocols, all other IP protocols and network frames (including but not limited to Ethernet network frame types). Using the RTA discussed above, network traffic may also be classified according to network protocol. The central manager 2 may define how protocols are to be provisioned in the network. For example, all TCP/IP based protocols may receive separate provisions from non-IP based traffic. The transport layer of the packet in FIG. 2 identifies the protocol used to provide the application traffic.

The third category involves identification of known and zero-day (un-cataloged) attacks and exploits by analyzing all inbound and outbound network packets across all protocols and ports without impacting network performance. Zero-day attacks are security vulnerability exploits which are unknown to the sysetm, therefore making it difficult to defend against them. Unknown network vulnerabilities are exploited by intruders and therefore it becomes difficult to guard a network vulnerability that isn't known in advance. The present systems may instantly detect zero-day attacks in order to automatically block them.

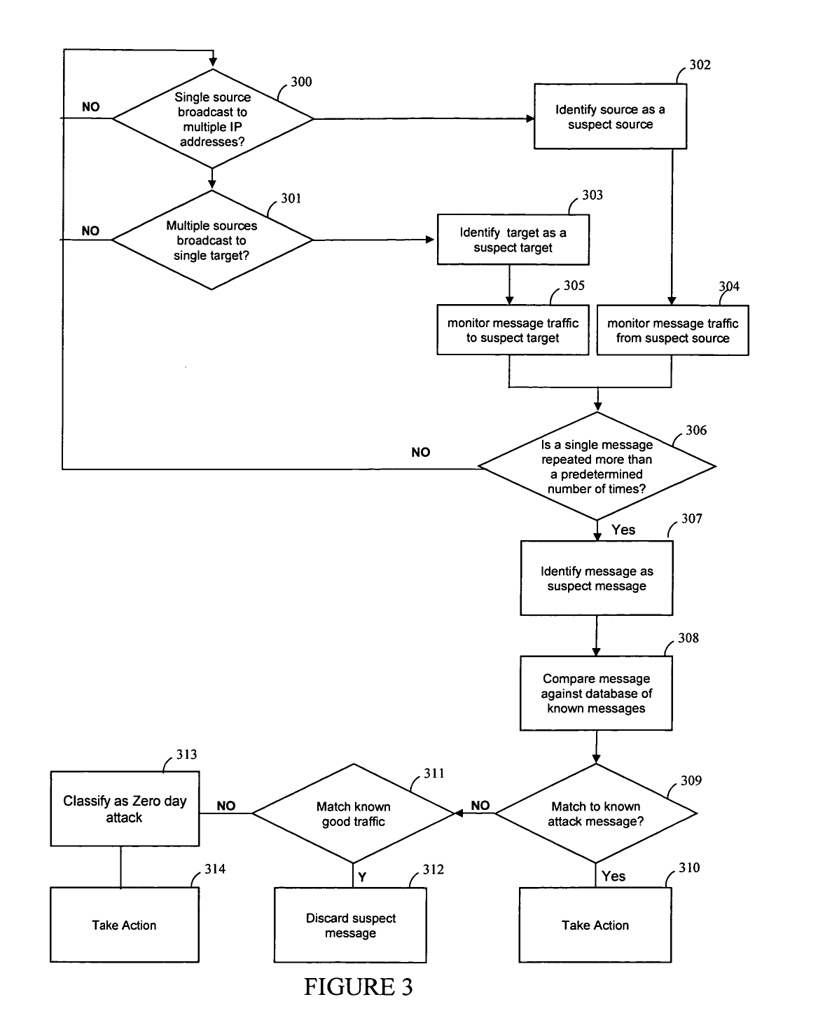

FIG. 3 shows a flow diagram for a method of identifying potential known and zero-day attacks and exploits. The steps of FIG. 3 are part of a device diversity algorithm employed to detect patterns of unauthorized traffic. The traffic sensors may observe one of two events including a single IP address broadcasting the same message to multiple IP address in step 300 or several IP addresses broadcasting the same packet or same URL request to a single target IP address in step 301. By observing traffic movement, especially movement that does not normally occur in the network, the present system can more efficiently pinpoint the source of a potential attack or security breach. Therefore, a traffic sensor may identify the source that is broadcasting to multiple destinations as an suspect source, in step 302. The same follows for a suspect target in step 303. In steps 304 and 305 the analysis tool 36 of the traffic sensor 8 investigates the message traffic of the suspect entity. The message can be in the form of either a data packet, handshake, or signal, or a portion of a data packet, handshake, or signal. Alternatively, the message can involve an exchange of data packets and signals, a portion of which, or collectively, constitute a message.

A decision is made at step 306 to determine whether the same message has repeated more than a predetermined number of times. If so, step 307 allows the traffic sensor to identify the message traffic as a suspect message followed by a comparison against a database of known messages in step 308. Optionally, the suspect message may be compared against network traffic currently or historically observed on the observed network or on multiple independent networks. If the entire message or important portions of the message match to an attack message profile (step 309), immediate action is taken to disrupt the attack message (step 310). These actions may be predefined actions to be taken determined by the central manager 2 and implemented as part of policies by the traffic sensor 8. Since the traffic sensor analyzes every packet against the entire rules set it can accurately block only threat-bearing packets without impeding legitimate traffic. Additionally, packet capture data is sent back to the central manager 2, in order to notify the administrator of the potential attack.

Otherwise, if the message matches known good traffic (step 312) the suspect message is discarded. Some circumstances may arise where the message cannot be classified as either known attack traffic or known good traffic. The present invention uses this information to classify the packet as a zero-day candidate in order to generate payload packet signatures or profile for the attack and begin to automatically drop those packets in steps 313 and 314. The immediate response to zero-day attack is to drop the packets before they can enter the network. A packet capture may be sent back to the central manager 2 to alert the administrator of the new attack. As such, the central manager creates the payload packet signature for the attack in order to make store it as a known attack profile.

In addition to identifying packets according to application, network protocol and attack, the traffic may be also be identified according to fourth category involving high-valued data. High value or confidential data formats, may include social security numbers, credit card numbers, and account information that are traversing the network unencrypted. Business specific proprietary data types (e.g., pricing, salaries, scheduling) can be easily added. The traffic manager may block the open routing of sensitive consumer data. Traffic sensors may employ a watch list of objects (e.g. binary/text patterns) in order to identify high value or confidential data. That is, a traffic sensor 8 may receive a list of objects to watch for while observing traffic from the central manager 2. RTA may find that packet payload data matches a stored binary/text pattern from the watch list. Once a traffic object is identified to match an object in the stored watch list, a traffic sensor takes special measures to log and securely manage the traffic, this may mean isolating the sensitive traffic to predetermined segments of the network. Packet capture data is sent back the central manager 2. As such, an administrator 6 can view the context in which the sensitive data was transferred, including the sender and recipient, and what application was used to transfer the data. Thus, if the content of the data is identified as high value or sensitive traffic, the context in which the content is sent may be provisioned to ensure data encryption or other security measures are taken to ensure secure data transfer. Alternatively, if confidential or sensitive traffic is detected to be leaving the network, countermeasures such as blocking traffic may be taken to prevent a security breach. These security measures may be defined by the policies associated with watch list objects and set forth by the central manager 2 to be enforced by the traffic sensor's enforcement component 38. In FIG. 2, the payload of the packet is inspected to determine if high value data is present while the Ethernet and Network layers of the packet identify the context in which the traffic is transmitted and received.

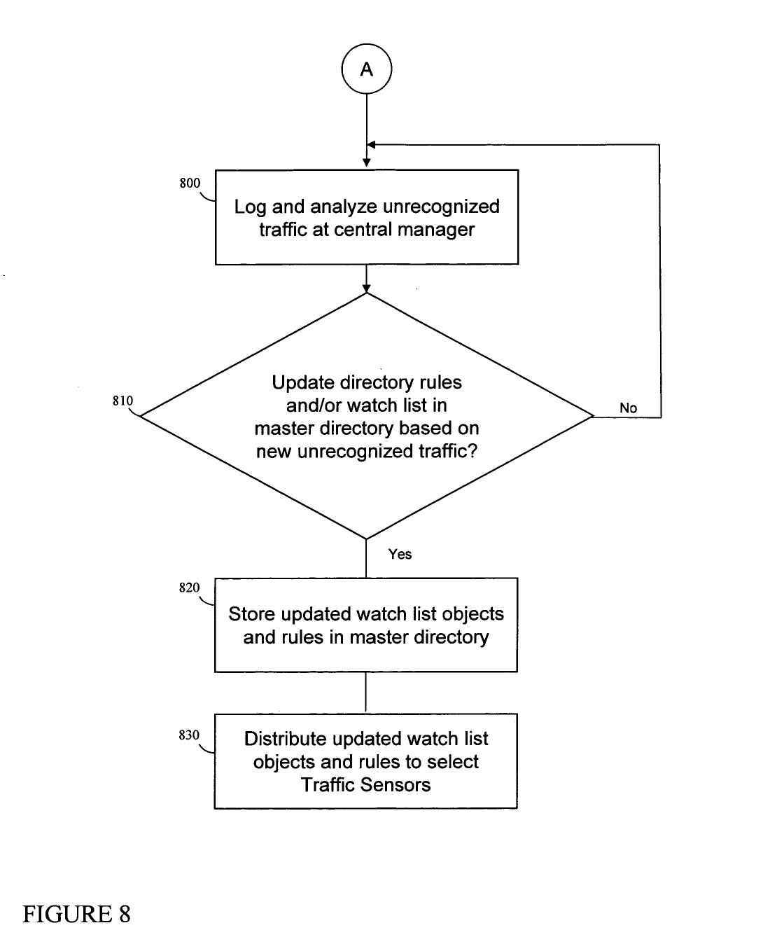

The central manager may automatically develop a watch list of objects including but not limited to, data keywords, digital watermarks and/or application traffic profiles by monitoring unrecognized data uploaded to a server, downloaded from a specific workstation, obtained from specific voice or video communications, or traveling across a specified network. Thus, the traffic sensor may be looking for a single occurrence of a string of data (e.g. keyword) or a series of occurrences within a sequence of traffic packets. In relation to FIG. 8, the watch list may be dynamically updated and distributed to traffic sensors.

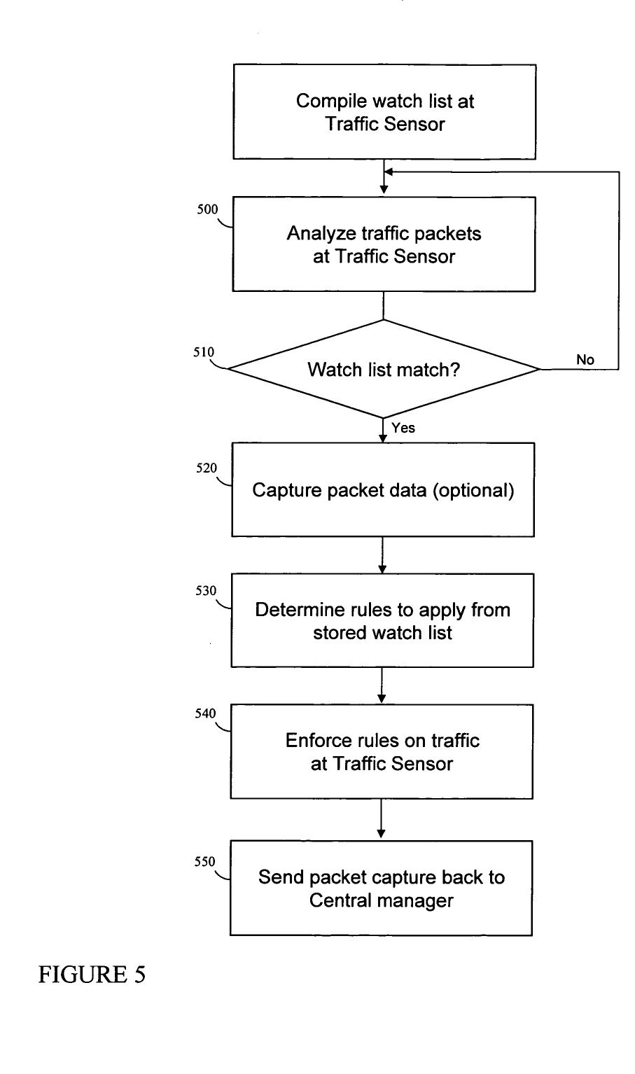

FIG. 5 shows a flow diagram for the method of distributing rules, watch list objects and policies to the traffic sensors 8, according to an embodiment of the invention. An administrator 6 can create directory entries in the master directory 22. Directory entries may include rules to be enforced and/or countermeasures or actions to be taken according to the identity of an application, protocol, or attack message, discussed above. Meanwhile, a watch list enforces rules according to the identification of high-valued traffic. The administrator may included user accounts, credentials, and permissions along with information about the business role of each user to be enforced when a user is detected to have logged in to the network in to the master directory 22 of the central manager in step 400. Similarly, step 410 allows an administrator of create a list of objects to be incorporated into a watch list stored into the master directory 22. The objects within a watch list may include, text, audio, packet, or any other pattern of data that the administrator wishes to identify in the traffic to trigger further action. Actions may be defined as countermeasures used to maintain a secure network. All directory entries and watch list objects are stored in step 420 to the master directory 22. The process of creating a watch list objects and directory rules may be performed before and/or during real-time traffic analysis. As such, in steps 430 and 440, each rules set 34 at the traffic sensors 8 is populated with directory rules and watch list objects as they are created, in order to instantly enforce policies. Distributing watch list and directory rules across several traffic sensors on a single network or host enable traffic evaluation and enforcements to be performed in parallel on the same observed data or network packet streams. To provide extra efficiency each traffic sensor may receive rules and watch list objects most relevant to a properties of the respective traffic sensor. Therefore, different traffic sensors may receive different rules and watch lists. Properties may include the location or network segment of the traffic sensor, the network assets identified on the network segment, packet capture data sent to the central manager, and/or bandwidth.

The parallel processing of data directory rules and watch lists allows for deep packet analysis on very high speed communication networks. Parallelizing the watch list creation, and the watch list comparison functions across multiple devices, or across multiple central processing units contained within a single device, enables deep packet analysis even in very high speed network environments. It is therefore feasible to build systems which provide real-time or near-real-time simple keyword matching, natural language processing, data rendering and other complex tasks on very high speed networks.

The watch list contains certain keywords or digital watermarks which may be an indication that sensitive traffic is attempting to traverse the network(s). Sensitive traffic may be of a suspicious nature or high-value traffic. The watch list may automatically define sensitivity levels for the objects contained within the watch list by rating the origin or destination of data. Various actions are defined if protected information is discovered on the network and these actions are defined within the watch list rules. Information observed leaving a specified host or traveling across a specified network is evaluated against the watch list in order for traffic sensors to take action or countermeasures to prevent security breaches. Actions are taken by the system if detected information is contained within a watch list. FIG. 5 is a flow diagram for the method of observing traffic against watch list objects, according to an embodiment of the invention. First, a traffic sensor 8 compiles the watch list received from central manager 2 and stores it in the rules set 34. Each traffic sensor monitors traffic via analysis tool 36 in step 510. Next, all traffic is monitored against the watch list to determine is a match occurs. If so, the packet capture data is made by the traffic sensor in step 530. From the compiled watch list, it is determined which rule or countermeasure to apply in step 540 for the matching watch list traffic. The traffic sensor's ability to conduct high speed analysis down to the payload level also allows the corresponding rules to be enforced in real-time reaction to the identified traffic. As the rule is triggered and then enforced, the packet capture data is sent back to the central manager 2.

The watch list also enables dynamic provisioning of QoS, VLANs and security parameters based on network traffic (e.g., observed data movement, application handshakes and/or access to specific networked resources by specific individuals packets). High value traffic may be dynamically tagged in order for the traffic sensor to control the flow of the tagged traffic across a network. For example, data streams that contain personally identifiable information are tagged so they may pass only through appropriate network segments, providing added security. Another example is to dynamically adjust the sensitivity metric for users based on the sensitivity of the data transferred by or to those users, thus enabling the system to dynamically increase the security of, or the scrutiny over, the network activities of those users. Therefore, the QoS and/or VLAN for the session to a specified user may be dynamically assigned, or existing QoS and/or VLAN may be dynamically adjusted, to ensure appropriate security and delivery assurance for a specific network communication. Dynamic identification and control over specific network communications also aids in identifying suspicious activity, isolating high-threat activity or taking high-threat resources completely off the network. Suspicious activity may be marked for further analysis. Thus, the system architecture allows real-time re-adjustment of security and QoS policies as necessary to refine performance or respond to specific network conditions.

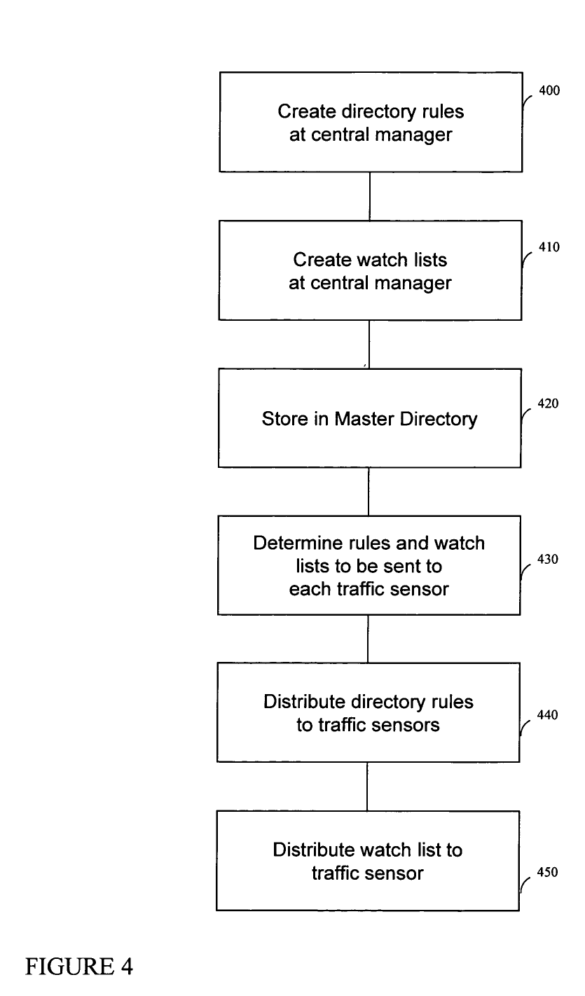

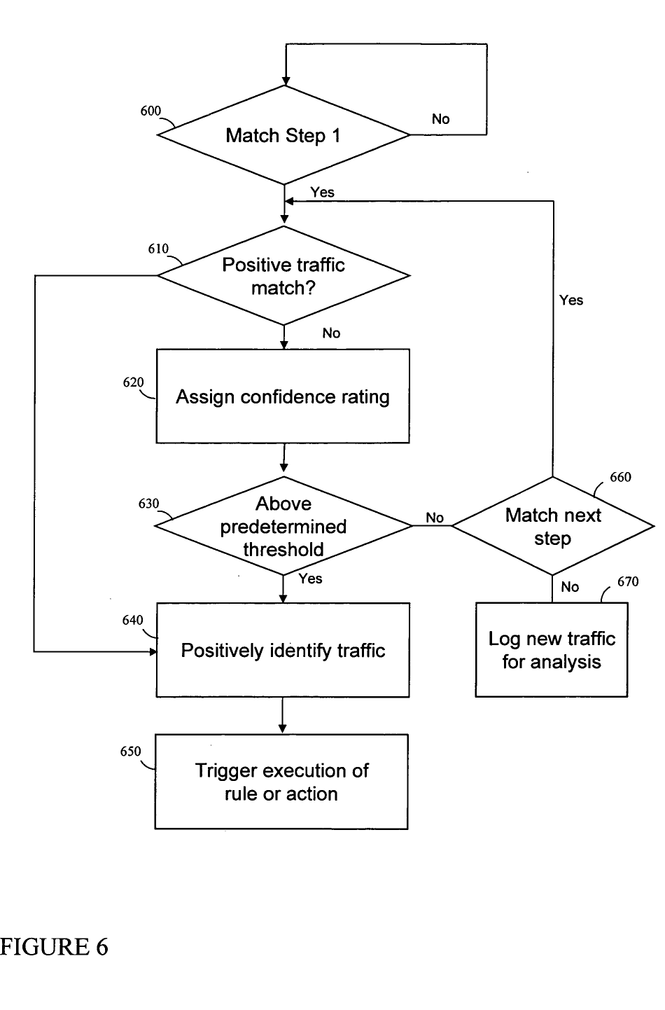

In an additional embodiment, watch lists may include traffic profiles stored in RTA format. RTA traffic profiles are a sequence of one or more steps that can be used to identify a type of communication (e.g. VoIP, VPN, application handshakes, database commands and responses, etc.) being performed on the network. Like packet matching, discussed above, an RTA traffic profile includes a sequence or series of messages exchanged by users, applications or devices in order to identify the type of application, user or device traffic attempting to traverse the network, which provides a bases on which to execute a rule. Each traffic profile stored in the watch list may have a corresponding predetermined rule or countermeasure or action to be taken upon the positive identification of a matching traffic profile within observed traffic. For example a file transfer handshake includes the steps for receiving a message to initiate a file transfer, sending a response message to confirm receipt of the file transfer request, and the subsequent file transfer itself. Each of the three steps described in this example may be used to detect a specific sub-activity of a network communication (for example, the message to initiate a file transfer), or the series of steps in total may be used to characterize a general activity (for example, the three steps described above may be referred to a successful file transfer request). A traffic profile may be created for a handshake wherein information regarding handshake steps, the sequence the steps are performed in, and the timing requirements from one step to the next are recorded and stored as a traffic profile. Multiple traffic profiles may be created and added to the watch list by the method shown in FIG. 4 and FIG. 6, discussed below. Unique features of the observed traffic may be picked out and used to characterize the steps, sequence, and timing for a traffic profile. Two of more transactions provide more information for creating the sequence of steps. Additionally, in another embodiment the administrator may choose to simulate new traffic on the network in order to force the creation of new traffic profiles.

Various traffic profiles may be used to identify all types of network communications, including, but not limited to, VoIP, e-commerce transactions, file transfers, suspicious activity, known attacks, worm traffic, botnet traffic, VPN login, client server interaction, Internet access, and/or streaming audio/video. As an example, a VoIP handshake profile may be created by simulating a VoIP session. A VoIP transaction begins with a call initiation, followed by observing voice payload and a signal protocol, then the last step wherein the call may be answered, which usually occurs within no more than 1 minute. Therefore, the VoIP handshake profile would include information regarding the sequence and timing of these steps. If in the future, traffic observed over the network(s) matches the steps in the same sequence and timing, then the observed traffic can be positively identified as a VoIP handshake connection, which means a user is attempting a VoIP session and should be given higher QoS in order to accommodate the session, or whatever the corresponding rule may be. It may be beneficial to profile as many steps as possible in order to create an accurate traffic profile. As a result, positively identified traffic may receive certain QoS and/or security parameters useful in accommodating the identified traffic.

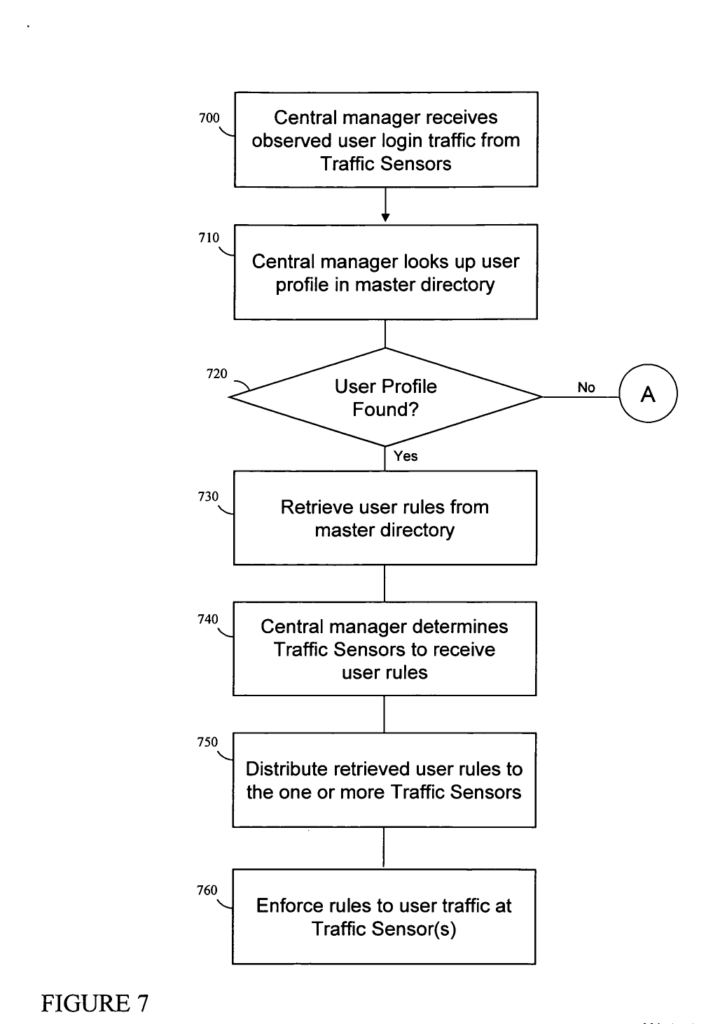

A confidence rating offers additional assurance with respect to qualifying observed traffic profiles. Confidence ratings may be assigned dynamically to observed traffic according to the number of steps completed from a traffic profile. As observed traffic passes the traffic sensor 8, it may match one or more steps of a traffic profile. For example, if it is observed that a series of packets match 2 out of 3 steps of a handshake profile, the observed communication is given a confidence rating of 66% for a handshake. FIG. 7 is a flow diagram demonstrating the method for identifying traffic profiles and assigning a confidence ratings. In step 600, it is determined whether the observed traffic matches a first step within in a traffic profile. If yes, the profile is checked for additional steps. If no more steps follow the first step then there is a 100% match with the traffic profile and the traffic is positively identified. If a positive traffic match is not made, meaning less than 100%, then a confidence rating is assigned in step 620, after which it is determined whether the confidence rating is greater than or equal to a predetermined threshold. The administrator may assign the predetermined threshold in the form of a percentage or ratio. Surpassing the threshold allows the positive identification of traffic and thus the execution of the corresponding rule for the identified traffic profile. If, however, the threshold is not matched or surpassed the next step in the traffic profile may be used to continue the matching process. If no match is found, the traffic is logged for future analysis by the central manager 2.

The method of FIG. 6 allows traffic to be dynamically rated in real-time. As packets are positively identified, actions may be taken at any point which the administrator sets as the confidence threshold. Beyond being one of the basis for executing rules, the confidence rating, in the form of a ratio or percentage, can present important data to the network administrator, as well. For quantitative measurements a confidence rating indicates the networks confidence level with respect to the traffic. For example, if only 2 out of 3 steps are completed the network is only 66% confident that the observed traffic is in fact the identified traffic. This allows various adjustments in setting confidence thresholds. Second, the confidence rating could indicate that there is a network problem preventing the traffic from reaching 100%, and therefore a network problem needs to be further investigated. For example, if it is observed that the same user is attempting the same communications multiple times without ever completing all the step, there could be a network problem needing further investigation. Or third, that not enough network resources (e.g. bandwidth, QoS, permissions, etc.) have been allocated to the user to complete a desired transaction. In all cases, communications may be logged for future analysis.

Furthermore, a predetermined confidence rating threshold may need to be matched or exceeded in order to positively identify communications and apply corresponding policies. For example, if a network administrator requires at least 70% confidence rating, a rating of only 66% would not qualify the traffic for corresponding policies. As such, have a greater number of steps could aid in qualifying traffic more effectively. Conversely, if the confidence rating does not reach a minimum threshold number it is logged and a network administrator may be notified that a potential problem is present within the network system or network resources need to be reallocated. As such, the watch list offers a sophisticated management mechanism for dynamically classifying, identifying, and qualifying network traffic.

Besides enforcing rules according to identification by application, protocol, attack, and/or high valued data (e.g. watch list), policies may also be enforced according to users identity. FIG. 7 shows a method for enforcing role based user controls, according to an embodiment of the invention. Role-based management simplifies administration of users and devices. Administrators grant rights and permissions by assigning a role or group to the users. Users and devices acquire these rights and permissions as they are assigned membership into the role. These roles determine how and where the network can be used. The level of control is based on the assigned role. Every time a user logs into the network via user computer or workstation, either locally or remotely, the central manager receives all the user's information from the observed traffic. Step 700 of FIG. 7 shows the central manager receiving the login information including characteristics of the packet including user computer's IP address, machine address, network location, time of day, user ID and/or other information. This information may be gleaned from authentication traffic captured by the traffic sensor 8 and transmitted to the central manager 2. In an alternative embodiment, the authentication traffic may be automatically transmitted to the central manager according to a predetermined relationship between the point of authentication and the central manager. As soon as the user authenticates to the network, at step 700, the authentication data is used to look up the user profile and role-based rules from the master directory 22. Various factor including, location of login, time-of-day, number of log-ins, and/or other factors may determine the role-based rules that should be assigned to the user. If a corresponding user profile is found in step 720, the role will define the user's permissions and corresponding rules, which may vary with respect to the factors listed above. The role-based rules are retrieved from within the master directory 22 in step 730. Then a determination is made as to which traffic sensors should receive the user's role based rules to enforce. Traffic sensor(s) located at the same network segment with the newly logged-in user may receive the rules. Additional traffic sensors may be determined based on proximity to user login location. Step 750 distributes the retrieved user's role based rules to the one of more traffic sensors 8 determined in step 740. All user traffic is enforced against the predetermined role of the user. The traffic sensor(s) (step 760) enforce role-based rules against the user. The exchange of user login data with the central manager 2 allows the traffic sensor(s) 8 to instantly begin to enforce rules and policies set forth by the network administrator on real-time traffic as it passes through the network.

The above mechanism for enforcing the various network management policies (e.g., QoS, security, bandwidth) may be in accordance with user credentials including, for example, role based controls. In other words, policies including, but not limited to, QoS levels, access rights, bandwidth utilization, secure transfer, and/or data encryption may be varied according to the role of a user within an organization. A role or group defines various users within a network. When a user logs in, his or her role is immediately identified using credential information accessed from master directory as shown if step 730 of FIG. 7, discussed above. Roles define what the user can and cannot do while on the network. Role based controls may be implemented at time of authentication and during user transactions.

As users log in and log out, the network is provisioned in real-time for each identified user, which may function to prevent a breach in security. By way of example, in a corporate network, human resource (HR) users may be assigned to group 1, which indicates that group 1 users may use email and access the web and HR records, but may not access financial records. Meanwhile, the accountants and financial officers assigned to group 2 may access email, web, and financial records but are not allowed to access HR records. Additionally, administrators assigned to group 3 may receive a higher QoS level when they login, in order to give their transactions higher priority on the network. Other factors may be included when considering role based controls such as time of day and location of the role based user. Thus, separate roles and policies are dynamically enforced for different users within the network according to their role within the organization.

Also, depending on the role, an authorized user 12 may have permissions to extend the directory in order to add entries or set traps to be logged. Authorized users can set up certain kinds of violations that should be monitored for by the traffic sensors. By way of example, HR may be interested in each occurrence of a social security number or curse word within a communication. The central manager 2 may log these events and the HR user(s) may receive periodic reports related to the occurrence of such events. Another example may involve an information security engineer interested in using the present invention to log access attempts to specific networked assets. This information may help the security engineer to configure the network management rules to avoid unauthorized access to specific resources or provide alerts to excessive failed access attempts. In sum, a role based user is subject to the permissions assigned to their role, which may allow the user to set up the system to monitor network events of interest to specific users and groups.

From FIG. 7, if user login data is not recognized traffic originating or destined to a recognized role based user (step 720) or identified as an application, protocol, attack or high valued traffic, the central manager 2 will begin to log and analyze such traffic for security purposes. For example, as unrecognized traffic begins to traverse the network, the unique features of the traffic may be identified in order to create new objects within a watch list (e.g. traffic profiles). In addition to user credentials like role based controls, which manage network traffic based on user identity (context), the watch list is employed to manage network traffic according to objects observed within the actual traffic flow (content). While role-based controls are predefined rules set by a network administrator, watch lists may be developed over time. FIG. 8 shows the procedure for creating traffic watch lists and directory rules for newly observed traffic. Step 800 begins with logging and analyzing unrecognized traffic. If it is determined at step 810 that the unrecognized traffic warrants updating the directory rules or a watch list, the modification to the directory and/or watch list are made then stored into the master directory 22 in step 820. New rules are distributed to the traffic sensors through out the network or only to selected traffic sensor(s) within a network segment in step 830.

In the foregoing specification, the invention has been described with reference to specific embodiments thereof. It will, however, be evident that various modifications and changes may be made thereto without departing from the broader spirit and scope of the invention. The specification and drawings are, accordingly, to be regarded in an illustrative rather than a restrictive sense.

What we claim is:

1. A system for monitoring and dynamically managing network traffic, comprising:
at least one central manager device including at least a rules creation and distribution module;
a plurality of network assets; and
at least a first network traffic sensor device and a second network traffic sensor device, wherein the network traffic sensor device include:
means for communicating with the at least one central manager;
means for receiving and analyzing packets passing through the network associated with the plurality of network assets using real-time traffic analysis; and
means for determining characteristics of the packets;
wherein the rules creation and distribution module comprises means for automatically distributing a first set of rules to the first network traffic sensor device and a second set of rules to the second network traffic sensor device, each of the sets of rules including rules to be enforced by the respective ones of the network traffic sensor devices in real-time in response to characteristics of the packets.

2. The system of claim 1, wherein the packet characterization is based at least in part on the occurrence of a string of data within the network traffic.

3. The system of claim 1, wherein the packet characterization is based on a series of occurrences of data within a sequence of network traffic packets.

4. The system of claim 1, wherein the set of rules includes countermeasures to be taken based on characteristics of the packets.

5. The system of claim 1, wherein the network traffic sensor devices comprise means for communicating to the central manager, packet capture data, including characteristics of the packets.

6. The system of claim 5, wherein the rules creation and distribution module creates a plurality of sets of rules and dynamically distributes rules to one or more selected network traffic sensor devices in real-time response to packet capture data communicated from a network traffic sensor device to the central manager regarding characteristics of packets received by the network traffic sensor device.

7. The system of claim 6, wherein the characteristics of packets includes one or more of: source data, destination data, payload data, application identification, protocol data, device identification data, network location data, time stamp data and user identification data.

8. The system of claim 6, wherein the one or more selected network traffic sensor devices is based on properties of each network traffic sensor device.

9. The system of claim 8, wherein the properties of the network traffic sensor device include network location, packet capture data sent, and bandwidth.

10. The system of claim 1, wherein each network traffic sensor device provides dynamic characterization of traffic packets passing through the network among a plurality of network assets, including at least application, data, user, and server traffic.

11. The system of claim 1, wherein each network traffic sensor device provides dynamic management of traffic based on the characteristics of the packets and the set of rules applicable to the network traffic sensor device.

12. The system of claim 1, wherein the means for dynamically determining characteristics of the packets includes means for enabling the network traffic sensor device to determine physical layer information, network layer information, transport layer information, session layer information, presentation layer information, application layer information and payload data from each packet received by the network traffic sensor device.

13. The system of claim 4 wherein the countermeasures include one or more action to: block, allow, re-route, drop, log, encapsulate, encrypt, tag, change QoS level, and adjust bandwidth utilization.

14. The system of claim 1, wherein the central manager stores one or more watch lists, the watch lists having packet characteristic information, a corresponding rule for the packet characteristics and countermeasures to be taken.

15. The system of claim 14, wherein the packet characterization is based on an occurrence of a string of data within network traffic.

16. The system of claim 14, wherein the packet characterization is based on a series of occurrences of data within a sequence of traffic packets.

17. The system of claim 14, wherein the central manager distributes unique watch lists to respective network traffic sensor devices.

18. The system of claim 14, wherein the network traffic sensor device determines whether received traffic packets match packet characteristic information from the watch list, and means for enforcing the corresponding rule and countermeasures for a determined match.

19. The system of claim 14, wherein the central manager includes:
means for receiving and logging packet capture data sent from the traffic sensor devices;
means for analyzing the logged packet capture data; and
means for dynamically updating the one or more watch lists based on the logged information.

20. The system of claim 1, wherein an authorized administrative user creates, edits or deletes rules at the central manager.

21. The system to claim 1, wherein the rules are dynamically created based on observed network activity.

22. The system of claim 1, wherein the set of rules distributed to the network traffic sensor device is based on at least the location of the network traffic sensor device.

23. The system of claim 1, wherein the network traffic sensor devices comprise:
means for detecting patterns of repetitive handshakes or packets generated by network assets;
means for dynamically creating signatures or attack profiles having those patterns; and
means for blocking attacks in real-time based on the dynamically created signatures or profiles.

24. The system of claim 23, wherein the network traffic sensor devices process and analyze the entire content of each observed packet against the created signatures or profiles to positively identify attack traffic.

25. A computer-based method for monitoring and dynamically managing network traffic, comprising the step of:
distributing a first set of rules and a second set of rules from a rule creation and distribution module of a central manager;
receiving the first set of rules and the second set of rules at a first network traffic sensor device and a second network traffic sensor device, respectively;
receiving and analyzing, using real-time traffic analysis, packets at the network traffic sensor device passing through the network and associated with a plurality of network assets;
determining characteristics of the packets;
enforcing rules by the respective ones of the network traffic sensor devices in real-time in response to characteristics of the packets.

26. The computer-based method of claim 25, wherein the packet characterization is based at least in part on the occurrence of a string of data within the network traffic.

27. The computer-based method of claim 25, wherein the packet characterization is based on a series of occurrences of data within a sequence of traffic packets.

28. The computer-based method of claim 25, wherein the set of rules includes countermeasures to be taken based on characteristics of the packets.

29. The computer-based method of claim 25, wherein the network traffic sensor devices comprise means for communicating to the central manager, packet capture data including characteristics of packets received by the network traffic sensor device.

30. The computer-based method of claim 29, wherein the rules creation and distribution module creates a plurality of sets of rules and dynamically distributes rules to one or more selected network traffic sensor devices in real-time response to information communicated from a network traffic sensor device to the central manager regarding characteristics of packets received by the network traffic sensor device.

31. The computer-based method of claim 30, wherein the characteristics of the packets include one or more of: source data, destination data, payload data, application identification, protocol data, device identification, network location data, time stamp data and user identification.

32. The computer-based method of claim 30, wherein the one or more network traffic sensor devices is based on properties of each network traffic sensor device.

33. The computer-based method of claim 32 wherein the properties of the network traffic sensor device include network location, packet capture data, and bandwidth.

34. The computer-based method of claim 25, wherein each traffic sensor device provides dynamic characterization of traffic packets passing through the network among a plurality of network assets, including at least application, data, user, and server traffic.

35. The computer-based method of claim 25, wherein each traffic sensor device provides dynamic management of traffic based on the characteristics of the packets and the set of rules applicable to the network traffic sensor device.

36. The computer-based method of claim 25, wherein the step of dynamically determining characteristics of the packets include enabling the traffic sensor device to determine physical layer information, network layer information, transport layer information, session layer information, presentation layer information, application layer information and payload data from each packet received by the network traffic sensor device.

37. The computer-based method of claim 28, wherein the countermeasures include one or more action to: block, drop, allow, re-route, log, encapsulate, encrypt, tag, adjust QoS level, and adjust bandwidth utilization.

38. The computer-based method of claim 25, wherein the central manager stores one or more watch lists, the watch lists having packet characteristic information, a corresponding rule for the packet characteristics and countermeasures to be taken.

39. The computer-based method of claim 38, wherein the packet characterization is based on an occurrence of a string of data within network traffic.

40. The computer-based method of claim 38, wherein the packet characterization is based on a series of occurrences of data within a sequence of traffic packets.

41. The computer-based method of claim 38, wherein the central manager distributes unique watch lists to respective network traffic sensors device.

42. The computer-based method of claim 38, wherein the network traffic sensor device determines whether received traffic packets match packet characteristic information from the watch list, and means for enforcing the corresponding rule and countermeasures for a determined match.

43. The computer-based method of claim 38, wherein the central manager includes the steps of:
receiving and logging packet capture data from the network traffic sensors about observed network traffic;
analyzing the logged packet capture data; and
dynamically updating the one or more watch lists based on the logged information.

44. The computer-based method of claim 25, wherein an authorized administrative user creates, edits or deletes certain rules at the central manager.

45. The computer-based method of claim 25, wherein the rules are dynamically created based on observed network activity.

46. The computer-based method of claim 25, wherein the set of rules distributed to the network traffic sensor device is based on at least the location of the network traffic sensor device.

47. The computer-based method of claim 25, wherein the network traffic sensor devices comprise the steps of:
detecting patterns of repetitive handshakes or packets generated by network assets;
dynamically creating signatures or attack profiles having those patterns; and
blocking attacks in real-time based on the dynamically created signatures or profiles.

48. The computer-based method claim 47, wherein the network traffic sensor devices process and analyze the entire content of each observed packet against the created signatures or profiles to positively identify attack traffic.
